(19) United States
(12) Patent Application Publication
(10) Pub. No.: US 2012/0212946 A1
(43) Pub. Date: Aug. 23, 2012

(54) MAGNETIC STICKER

(76) Inventors: Shalom SHMUEL, Moshav Amioz (IL); Shmuel SHABO, Kiryat Ekron (IL); Galil NAHOOM, Moshav Mivtahim (IL)

(21) Appl. No.: 13/397,949

(22) Filed: Feb. 16, 2012

Related U.S. Application Data
(60) Provisional application No. 61/444,813, filed on Feb. 21, 2011.

(51) Int. Cl. F21L 4/02

(52) U.S. Cl. 362/184

(57) ABSTRACT

A Light Emitting Diode (LED) illuminated magnetic card is provided herein. The card may include: a flexible magnetic layer, a plurality of LED, a LED circuit board to station the plurality of LED, a microcontroller to operate the plurality of LED, a movement measuring instrument to turn on and off the plurality of LED, a plurality of button cells to provide power to turn on the plurality of LED, a foam layer with at least one suitable alcove for the LED circuit board mounted on top of the flexible magnetic layer and a flexible sticker mounted on top of the LED illuminated magnetic card.

### BACKGROUND

1. Technical Field

The present invention relates to the field of magnetic cards, and more particularly, to Light Emitting Diode (LED) illuminated magnetic cards controlled by a movement measuring instrument.

2. Discussion of the Related Art

Prior to setting forth the background of the related art, it may be helpful to set forth definitions of certain terms that will be used hereinafter.

The term “movement measuring instrument” as used herein in this application, is defined as a device that makes or breaks an electric circuit when shaken or stands still respectively.

The term “microcontroller” as used herein in this application, is defined as a small computer on a single integrated circuit. The functionality of the microcontroller is to control the operation of the light emitting diodes.

Light Emitting Diode (LED) illuminated magnetic cards exist in decorative industry for quite some time. These LED illuminated magnetic cards may be attached to any magnetic plate, such as a magnetic surface in a vehicle, a refrigerator, a magnetic wall and the like.

These LED illuminated magnetic cards, known in the art, comprised of a sticker body, a plurality of LEDs and a control circuit on the sticker body. Further, a battery cell for providing the LEDs with the necessary power, and a flexible magnetic pad at the bottom side of the sticker body to attach the LED illuminated magnetic card to a magnetic plate.

### BRIEF SUMMARY

Embodiments of the present invention provide a magnetic card with several LED lights, controlled by a movement measuring instrument. The magnetic card is aimed to be positioned on a magnetic plate in motion such as a vehicle, using the movement measuring instrument to turn on the LED lights in the magnetic card when the vehicle moves and turn off the LED lights in the magnetic card when the vehicle stops.

According to an aspect of the present invention, the LED lights in the magnetic card is configured to turn on when the vehicle is in motion and to turn off when the vehicle stops.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is an exploded view of a LED illuminated magnetic card illustrating internal parts of the magnetic card, according to some embodiments of the invention;

FIG. 2 is a perspective view of the LED illuminated magnetic card illustrating all internal parts of the magnetic card, positioned in their place, to some embodiments of the invention; and

FIG. 3 is a perspective view of the LED illuminated magnetic card.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner:

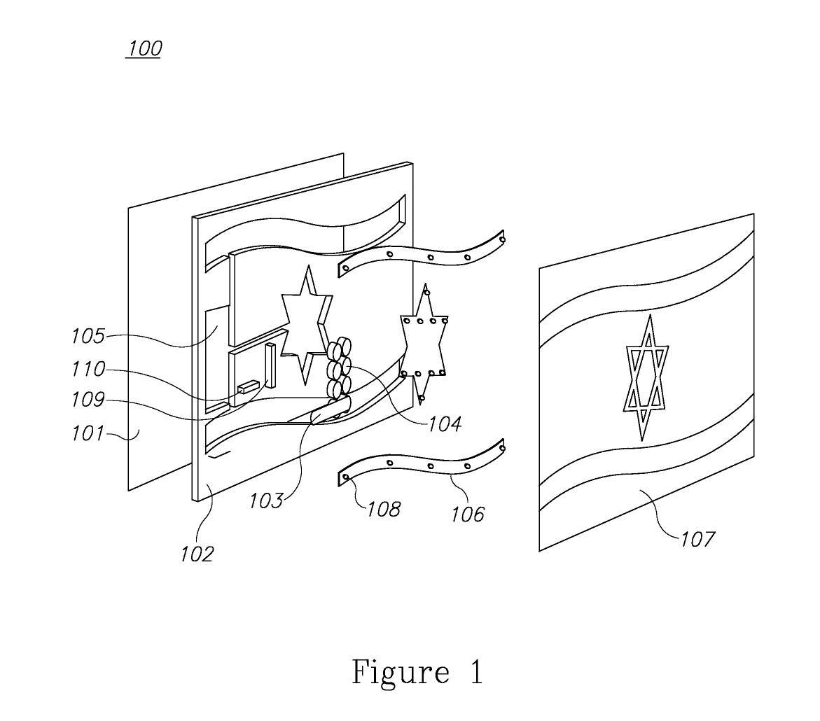

FIG. 1 is an exploded view of a magnetic card illustrating all internal parts of a magnetic card, according to some embodiments of the invention. a flexible magnetic layer 101 and attached to it a foam layer 102 with at least one suitable alcove 105 for at least one compatible in shape Light Emitting Diode (LED) circuit board 106 with a plurality of LED 108. The foam layer 102 also has a suitable alcove 105 for a microcontroller 110 and a plurality of button cells 104 with a removable tab for the button cell 103 and a movement measuring instrument 109. On top of the foam layer 102 a vinyl sticker 107 affixed to it.

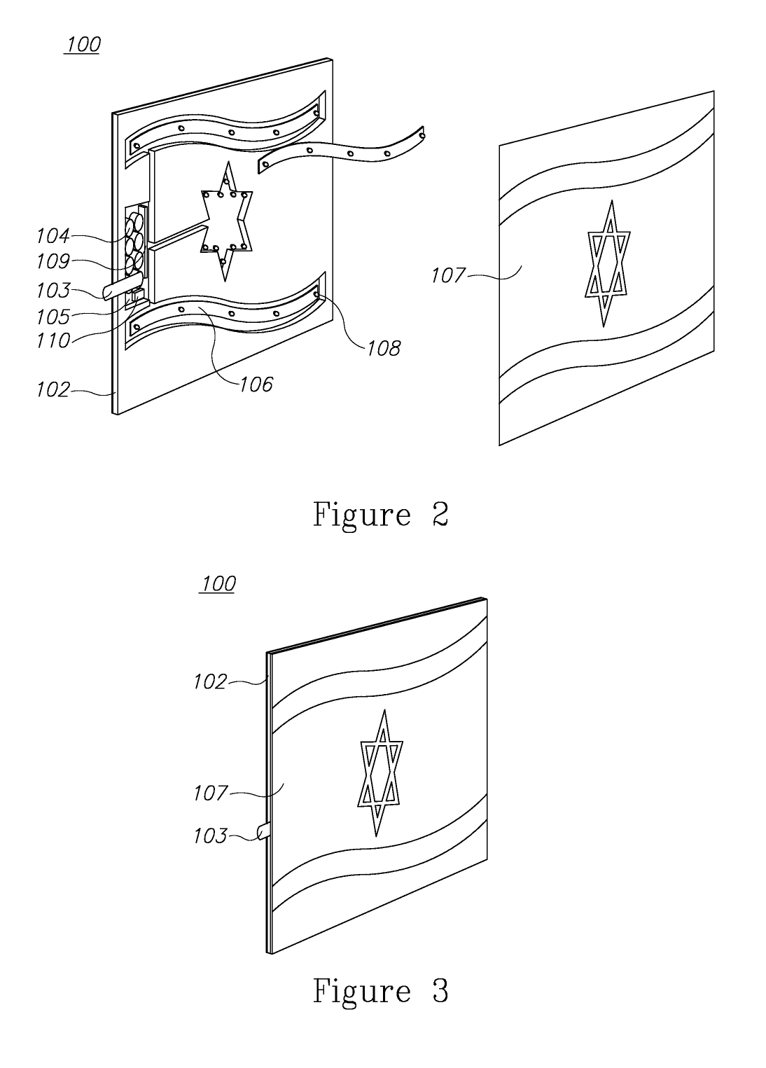

FIG. 2 is a perspective view of the LED illuminated magnetic card illustrating all internal parts of the LED illuminated magnetic card, combined in the foam layer 102 according to some embodiments of the invention. A plurality of LED circuit boards 106 is positioned in a suitable alcove 105 in the foam layer 102. The plurality of button cells 104 and the removable tab for the button cell 103 and the microcontroller 110 are positioned in a suitable alcove 105.

FIG. 3 is a perspective view of the LED illuminated magnetic card 100. The foam layer 102 is covered with a sticker 107. The removable tab for the button cell 103 is protrusive.

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A Light Emitting Diode (LED) illuminated magnetic card comprising:
a flexible magnetic layer;
a plurality of light emitting diodes (LED);
a LED circuit board arranged to station the plurality of LED;
a microcontroller configured to control the operation of the plurality of LED;
a movement measuring instrument configured to start and stop the operation of the plurality of LED;
a plurality of button cells to provide power for the plurality of LED;
a foam layer with at least one suitable alcove for the LED circuit board mounted on top of the flexible magnetic layer; and
a sticker mounted on top of the LED illuminated magnetic card.

2. The LED illuminated magnetic card according to claim 1, wherein the plurality of button cells sits in an alcove with a removable tab to put new or replace the button cells.

3. The LED illuminated magnetic card according to claim 1, wherein the sticker is made of vinyl to support flexibility of the LED illuminated magnetic card.

4. The LED illuminated magnetic card according to claim 1, wherein the foam layer has an alcove in a size suitable for the movement measuring instrument and the microcontroller.

5. The LED illuminated magnetic card according to claim 1, wherein the plurality of button cells has the capacity to turn on the plurality of LED.
